(19) United States
(12) Patent Application Publication
(10) Pub. No.: US 2026/0084652 A1
(43) Pub. Date: Mar. 26, 2026

(54) Digital Key System for Vehicles and Operating Method Thereof

(71) Applicants: Hyundai Motor Company, Seoul (KR); Kia Corporation, Seoul (KR)

(72) Inventor: Jae Won Jung, Hwaseong-Si (KR)

(21) Appl. No.: 19/255,794

(22) Filed: Jun. 30, 2025

(30) Foreign Application Priority Data
Sep. 25, 2024 (KR) 10-2024-0130205

(51) Int. Cl. B60R 25/24; B60R 25/04; B60R 25/25

(52) U.S. Cl. CPC B60R 25/24; B60R 25/04; B60R 25/252; B60R 25/255

(57) ABSTRACT

The present disclosure provides a vehicle digital key system including a digital key management server and a vehicle. The vehicle may be configured to transmit, to the digital key management server and based on a user terminal being located within a threshold distance from the vehicle, a digital key authentication request. The digital key management server may be configured to transmit, to the user terminal, the digital key authentication request. The digital key authentication request may cause the user terminal to perform, based on the digital key authentication request and based on biometric identification information of a user, authentication of the user; and transmit, to the digital key management server, an authentication response. The digital key management server may be further configured to transmit, to the vehicle, the authentication response. The vehicle may be further configured to perform an operation of the vehicle.

### CROSS-REFERENCE TO RELATED APPLICATION

This application claims priority to Korean Patent Application No. 10-2024-0130205, filed on Sep. 25, 2024, the entire content of which is hereby incorporated by reference for all purposes.

### TECHNICAL FIELD

The present disclosure relates to vehicle security, and more security a vehicle digital key system.

### BACKGROUND

Technological advances have made available a variety of vehicle amenities. For example, a user may use their digital key (e.g., a smartphone) to control a vehicle to start, lock or unlock the doors of the vehicle, roll up or down the windows of the vehicle, or regulate the temperature in the vehicle.

A communication protocol for data exchange between the digital key and the vehicle may be a standardized protocol, such as the car connectivity consortium (CCC) standard. In accordance with the communication protocol defined in the CCC standard, a vehicle manufacturer and a smartphone manufacturer may develop and manufacture their respective products.

### SUMMARY

One object of one or more example embodiments of the present disclosure is to solve the challenges described above.

An aspect of the present disclosure is to provide a digital key system and an operating method thereof, which may prevent malfunctions in remote locations using a Bluetooth Low Energy (BLE) received signal strength indicator (RSSI) (BLE RSSI) value and may perform digital key authentication by a digital key management server by verifying biometric information (e.g., fingerprint) of a pre-authenticated user through an application on a user terminal interworking with the digital key management server operating a remote vehicle control service, thereby improving the efficiency of a digital key authentication control technology, expanding the usability of a digital key, enhancing the user convenience, and significantly reducing the production cost of the vehicle without a need for a separate additional device for the vehicle.

According to one or more example embodiments of the present disclosure, a vehicle digital key system may include: a digital key management server; and a vehicle configured to transmit, to the digital key management server and based on a user terminal being located within a threshold distance from the vehicle, a digital key authentication request. The digital key management server may be configured to transmit, to the user terminal, the digital key authentication request. The digital key authentication request may cause the user terminal to: perform, based on the digital key authentication request and based on biometric identification information of a user, authentication of the user; and transmit, to the digital key management server, an authentication response indicating a result of the authentication. The digital key management server may be further configured to transmit, to the vehicle, the authentication response. The vehicle may be further configured to perform, based on the authentication response, an operation of the vehicle.

The biometric identification information may include at least one of: fingerprint information, iris information, facial feature information, or finger vein recognition information.

The threshold distance may be determined based on a median of Bluetooth Low Energy (BLE) electric field strength values.

The digital key management server may be further configured to: receive, from the user terminal, a vehicle control request associated with the vehicle.

The vehicle may be configured to perform the operation of the vehicle by: performing the operation based on the vehicle control request.

According to one or more example embodiments of the present disclosure, a method performed by an apparatus of a vehicle may include: detecting a user terminal being located within a threshold distance from the vehicle; based on the detecting of the user terminal located within the threshold distance from the vehicle, transmitting, to the user terminal via a digital key management server, a digital key authentication request; receiving, from the digital key management server, an authentication response indicating a result of authentication performed, based on biometric identification information of a user, by the user terminal; and performing, based on the authentication response, an operation of the vehicle.

Receiving the authentication response may include receiving the authentication response from the user terminal via the digital key management server.

The method may further include: based on receiving of the authentication response, transmitting, by the vehicle to the digital key management server, a request to verify a signal for controlling the vehicle.

The method may further include: transmitting, by the digital key management server to the user terminal, a request to select one of a plurality of operations associated with control of the vehicle.

The method may further include: receiving, from the user terminal via the digital key management server, a vehicle control request associated with the operation of the vehicle.

Receiving the vehicle control request may be based on a result of authentication performed by the user terminal.

Performing the operation of the vehicle may include: performing the operation based on the vehicle control request.

According to one or more example embodiments of the present disclosure, a method performed by a server may include: receiving, from a vehicle and based on a user terminal being located within a threshold distance from the vehicle, a digital key authentication request; transmitting, to the user terminal, the digital key authentication request; receiving, from the user terminal, an authentication response indicating a result of authentication performed, based on biometric identification information of a user, by the user terminal; and causing the vehicle to perform an operation, wherein the causing of the vehicle to perform the operation comprises transmitting the authentication response to the vehicle.

The method may further include: receiving, from the vehicle, a request to verify a signal for controlling the vehicle.

The method may further include: transmitting, to the user terminal and based on the receiving of the request to verify the signal for controlling the vehicle, a request to select one of a plurality of operations associated with control of the vehicle.

The method may further include: receiving, from the user terminal, a vehicle control request indicating the operation.

The method may further include: transmitting, to the user terminal and based on the receiving of the vehicle control request, a request to perform a second authentication of the user; receiving, from the user terminal, a result of the second authentication; and transmitting, based on the result of the second authentication, the vehicle control request to the vehicle.

Causing the vehicle to perform the operation may further include transmitting, to the vehicle, the vehicle control request.

At least one embodiment of the present disclosure provides a digital key system and an operating method thereof, which may, even for a user possessing a user terminal that does not have a UWB communication function, perform digital key authentication by a digital key management server by verifying biometric information (e.g., fingerprint) of a pre-authenticated user through an application on a user terminal interworking with the digital key management server operating a remote vehicle control service, thereby improving the efficiency of a digital key authentication control technology, expanding the usability of a digital key, enhancing the user convenience, and significantly reducing the production cost of the vehicle without a need for a separate additional device for the vehicle.

### BRIEF DESCRIPTION OF THE DRAWINGS

FIG. 1 is a diagram illustrating a concept of an example digital key system for a vehicle.

FIG. 2 is a diagram illustrating an example configuration of a vehicle.

FIG. 3 is a diagram schematically illustrating a configuration of an example digital key management server.

FIG. 4 is a diagram schematically illustrating a configuration of an example application on a terminal.

FIG. 5, FIG. 6, and FIG. 7 illustrate a method of operating an example digital key system for a vehicle.

FIG. 8 shows an example computing system.

### DETAILED DESCRIPTION

Hereinafter, one or more example embodiments of the present disclosure will be described in detail with reference to the accompanying drawings. The example embodiments are not construed as limited to the disclosure and should be understood to include all changes, equivalents, and replacements within the idea and the technical scope of the disclosure.

The terms “module,” “unit,” and/or “-er/-or” for referring to elements are assigned and used interchangeably in consideration of the ease of explanation, and thus the terms per se do not necessarily have different meanings or functions. The terms “module,” “unit,” and/or “-er/-or” do not necessarily require physical separation.

Although terms including ordinal numbers, such as, “first,” “second,” and the like, may be used herein to describe various elements, the elements are not limited by these terms. These terms are only used to distinguish one element from another.

The term “and/or” is used to include any combination of multiple items that are subject to it. For example, “A and/or B” may include all three cases, for example, “A,” “B,” and “A and B.”

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

When n element is described as “coupled” or “connected” to another element, the element may be directly coupled or connected to the other element. However, it is to be understood that another element may be present therebetween. In contrast, when an element is described as “directly coupled” or “directly connected” to another element, it is to be understood that there are no other elements therebetween.

The singular forms “a,” “an,” and “the” are intended to include the plural forms as well, unless the context clearly indicates otherwise. It is to be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

In addition, the term “unit,” “control unit,” “control device,” or “controller” is merely a widely used term for naming an element that controls a specific function, and does not mean a generic functional unit. For example, each controller may include a communication device that communicates with another controller or a sensor to control a function assigned thereto, a memory that stores an operating system (OS), a logic command, input/output information, and the like, and one or more processors that perform determination, calculation, computation, decision, and the like that are necessary for controlling a function assigned thereto.

Meanwhile, a processor may include a semiconductor integrated circuit and/or electronic devices that perform at least one or more of comparison, determination, computation, and decision to achieve programmed functions. The processor may be, for example, any one or a combination of a computer, a microprocessor, a central processing unit (CPU), an application-specific integrated circuit (ASIC), an electronic circuitry, and a logic circuitry.

In addition, computer-readable recording media (or simply memory) include all types of storage devices that store data readable by a computer system. The storage devices may include at least one type of, for example, flash memory, hard disk, micro-type memory, card-type (e.g., secure digital (SD) card or extreme digital (XD) card) memory, random-access memory (RAM), static RAM (SRAM), read-only memory (ROM), programmable ROM (PROM), electrically erasable PROM (EEPROM), magnetic RAM (MRAM), magnetic disk, or optical disc.

This recording medium may be electrically connected to the processor, and the processor may load and record data from the recording medium. The recording medium and the processor may be integrated or may be physically separated.

At least in some implementations, for a digital key using Bluetooth Low Energy (BLE) and ultra-wideband (UWB) protocols, a portable user terminal (e.g., a smartphone) that supports BLE and UWB communication may be used to track a location of a user, functions, such as locking and unlocking doors of a vehicle and starting the engine or motor of the vehicle, may be provided based on the tracked location.

To perform UWB communication, BLE communication may be first performed to set the parameters of UWB communication. That is, BLE communication may be used to allow a smartphone and a vehicle to share the parameters of UWB communication therebetween.

Due to the recency of the UWB technology, some smartphones (especially some lost-cost smartphone models) may not yet support the UWB communication functionality. Thus, many vehicle drivers may be able to take full advantage of digital keys using the UWB function.

Other digital key authentication methods may include, for example, a near-field communication (NFC)-based authentication system and a fingerprint authentication system. However, the fingerprint authentication system may require a dedicated fingerprint authentication device, such as a fingerprint scanner, that allows a user to attempt authentication in a vehicle using a fingerprint of a registered driver. Moreover, authentication for starting the vehicle using fingerprint authentication may not be necessary if the driver possesses one of a fob (e.g., a key fob) or a digital key, which is required to enter the vehicle.

Also, the NFC function-based authentication method may present some problems where a mobile phone to be used for authentication needs to be tagged (e.g., come in proximity or physical contact) to a door handle and/or placed on a wireless charger when starting a vehicle. This may pose additional challenges for vehicle developers, increase the cost for parts, and/or increase the complexity of development specifications due to the application of NFC antennas to the door handle and the wireless charger.

Hereinafter, a digital key system for a vehicle and a method of operating the digital key system, according to one or more example embodiments of the present disclosure, will be described in detail with reference to the accompanying drawings.

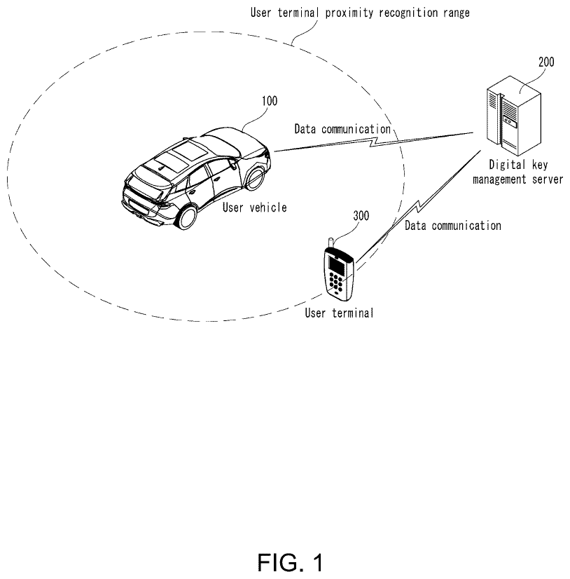

FIG. 1 is a diagram illustrating a concept of a digital key system for a vehicle. A user terminal 300 may have no ultra-wideband (UWB) function itself or may not be able to use the UWB function, for example, due to damage thereto. In this case, the user terminal 300 may have an application installed thereon that allows it to perform requested digital key authentication by being connected to a digital key management server 200.

The digital key management server 200 may interact with the application installed on the user terminal 300 to transmit and/or receive requests and responses between a user vehicle 100 and the user terminal 300. The digital key management server 200 may be involved (e.g., directly involved) in the digital key authentication if necessary.

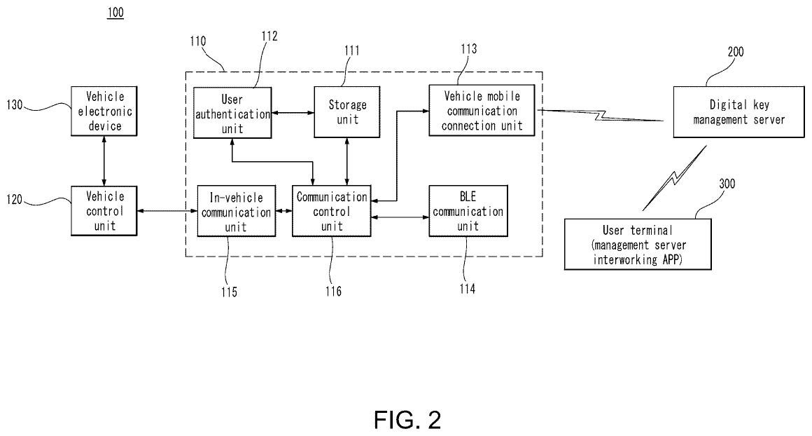

FIG. 2 is a diagram illustrating an example configuration of a vehicle. The user vehicle 100 may include: a vehicle control unit 120 using a remote control command for locking/unlocking doors of the user vehicle 100 and opening/closing a trunk of the user vehicle 100, a remote control command for turning on/off (e.g., start or terminate) the vehicle, or a payment means (e.g., credit card information) provided in the user vehicle 100 to make payments using an external payment terminal; a vehicle electronic device 130 configured to operate under the control of the vehicle control unit 120 and provide a result of the operation; and a vehicle authentication unit 110 to which a multi-communication method is applied.

The vehicle authentication unit 110 may include: a storage unit 111 storing information of the user terminal 300 that is already registered; a vehicle mobile communication connection unit (also referred to as a vehicle mobile communication interface) 113 configured to communicate with the digital key management server 200; a Bluetooth Low Energy (BLU) communication unit (also referred to as a BLU communication interface) 114 configured to detect whether the user terminal 300 is located within a predetermined threshold range (e.g., a threshold distance); and a communication control unit 116 configured to, if it is determined that the user terminal 300 is close to a vehicle via the BLE communication unit 114, transmit a digital key authentication request to the digital key management server 200, and check whether there is a response to the digital key authentication request.

In this case, the vehicle authentication unit 110 may further include a user authentication unit 112 configured to authenticate the user terminal 300 based on information of the user terminal 300 stored in the storage unit 111 and digital key authentication information received via the digital key management server 200.

The BLE communication unit 114, which is a communication module for performing wireless communication with the user terminal 300 by a Bluetooth communication method, may transmit and receive wireless signals of a preset frequency band via an antenna (not shown).

The BLE communication unit 114 may also be implemented in the form of a communication module capable of performing BLE communication, and BLE is a Bluetooth-based communication protocol that was provided with the advent of Bluetooth 4.0 version and: focuses on minimizing power consumption and extending battery life. It is also a communication protocol that is widely used particularly among wearable devices due to its low power characteristics, although it is relatively slow compared to other wireless transmission standards.

In this case, the threshold range (e.g., a threshold distance) may be based on one or more received signal strength indicator (RSSI) values in BLE communication that are greater than or equal to a certain value. An RSSI value may be generally represented as a value from 0 to −100. In this case, a value closer to zero (0) may be determined to be closer in distance.

For example, if the value tends to increase from −50, the digital key management server 200 may request the user terminal 300 to perform digital key authentication.

If the measurement starts from value that is too low (e.g., if the threshold distance is too far), it may cause the vehicle 100 to wake up from an undesirably long distance, which may cause the vehicle 100 to be discharged more quickly.

The storage unit 111 may store pairing information, authentication information, encryption information, and the like of the user terminal 300. For example, the pairing information and the authentication information of the user terminal 300 may be registered by the communication control unit 116 during initial communication with the user terminal 300 via the BLE communication unit 114.

Further, control request information based on digital key authentication by biometric information authentication may be received from the digital key management server 200 via the mobile communication connection unit 113.

The communication control unit 116 may also perform overall control necessary to communicate with the user terminal 300 via the BLE communication unit 114.

Upon checking the biometric information of the user and receiving a vehicle control request signal from the digital key management server 200 via the mobile communication connection unit 113, the communication control unit 116 may provide this to the user authentication unit 112 and may control the user authentication unit 112 or the storage unit 111 such that the user authentication unit 112 authenticates the user terminal 300 using authentication data stored in the storage unit 111.

Further, the communication control unit 116 may control an in-vehicle communication unit 115 to perform communication with the vehicle control unit 120 provided in the user vehicle 100.

In this case, the in-vehicle communication unit 115 may transmit a remote control command received by being transmitted from the user terminal 300 while communicating with the vehicle control unit 120 under a controller area network (CAN) communication standard to lock/unlock the doors and open/close the trunk of the user vehicle 100, and turn on/off the start (e.g., ignition or start-up of an engine or motor), by the remote control command, or perform a payment using an external payment terminal or the like by a payment method provided in the vehicle 100.

In this case, the vehicle control unit 120 may control the operation of the vehicle electronic device indicated by reference numeral 130 and acquire data generated from the operation.

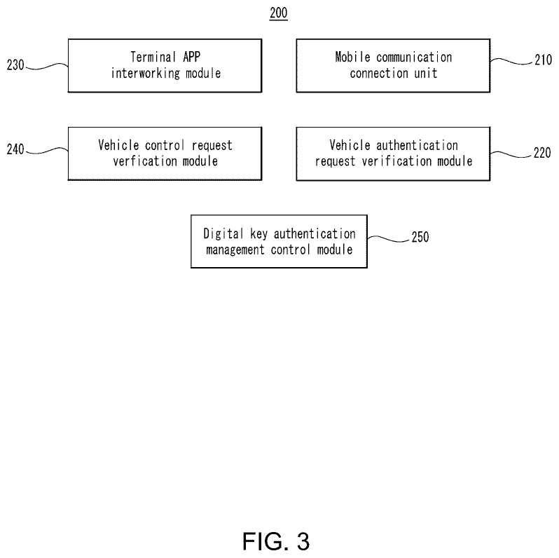

FIG. 3 is a diagram schematically illustrating a configuration of an example digital key management server. The digital key management server 200 may include: a mobile communication connection unit 210 configured to perform data communication with the vehicle 100 and/or the user terminal 300; a vehicle authentication request verification module 220 configured to verify an authentication request generated by the vehicle 100 via the mobile communication connection unit 210; a terminal APP interworking module 230 configured to interwork with the application installed on the user terminal 300 via the mobile communication connection unit 210; a vehicle control request verification module 240 configured to verify a request related to vehicle control (such as ignition on or vehicle door lock) through the application installed on the user terminal 300; and a digital key authentication management control module 250 configured to control the components and perform digital key authentication management.

It is to be noted that the configuration of the digital key management server 200 is not limited to the preceding example but is shown only for illustrative purposes.

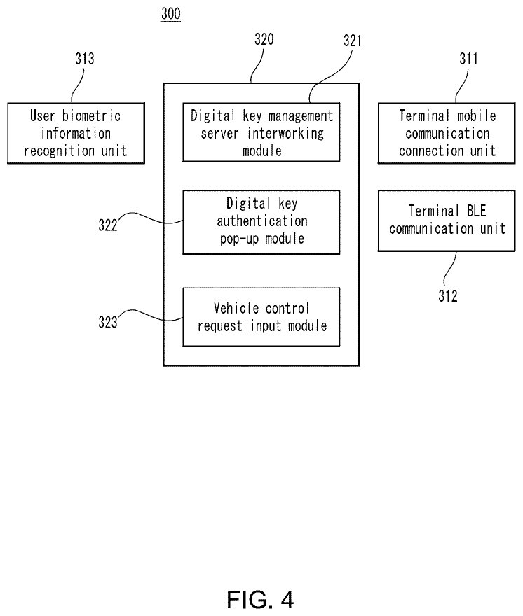

FIG. 4 is a diagram schematically illustrating a configuration of an example application on a terminal. The user terminal 300 may be broadly divided into an application indicated by reference numeral 320 and a basic configuration of the terminal 300. The basic configuration may include a terminal mobile communication connection unit 311, a terminal BLE communication unit 312, and a user biometric information recognition unit 313. It is to be noted that the basic configuration of the user terminal 300 is not limited to the preceding but is shown only for illustrative purposes.

The user biometric information recognition unit 313 may generally relate to fingerprint recognition, but may also relate to biometric information recognition such as iris recognition, facial recognition, or finger vein recognition.

The application indicated by reference numeral 320 may include: a digital key management server interworking module 321 configured to interwork with the terminal APP interworking module 230 of the digital key management server 200; a digital key authentication pop-up module 322 configured to pop up a digital key authentication request (or biometric information input request) screen on a display screen of the user terminal 300 as the digital key management server interworking module 321 operates; and a vehicle control request input module 323 configured to enable the user to input a vehicle control request, after the biometric information is input onto the digital key authentication request screen via the digital key authentication pop-up module 322 and is authenticated by the user biometric information recognition unit 313 and the user authentication is then completed accordingly.

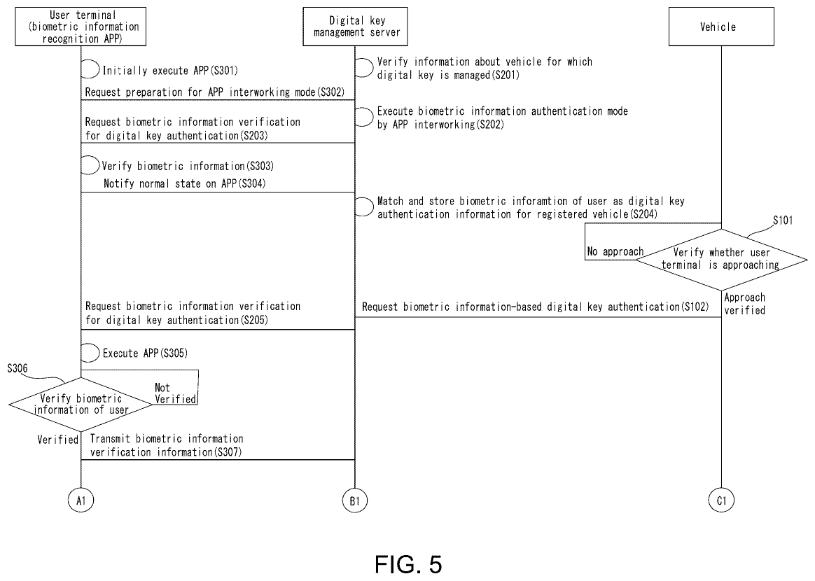

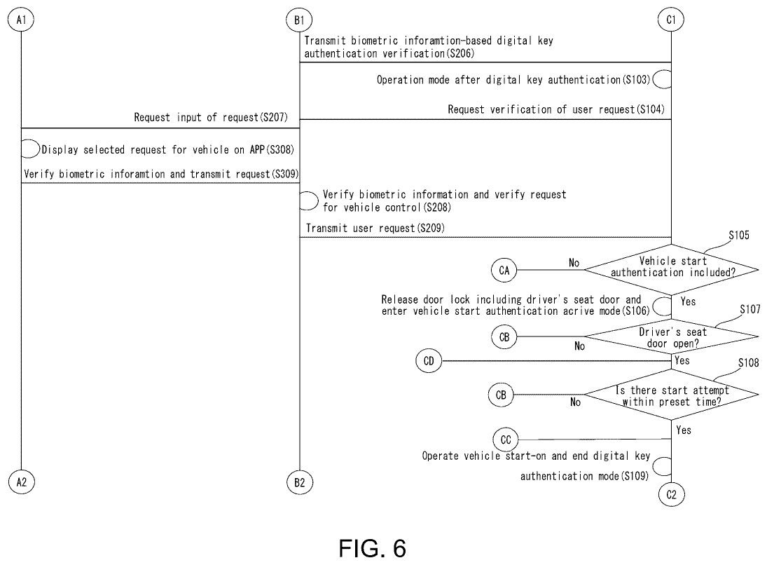

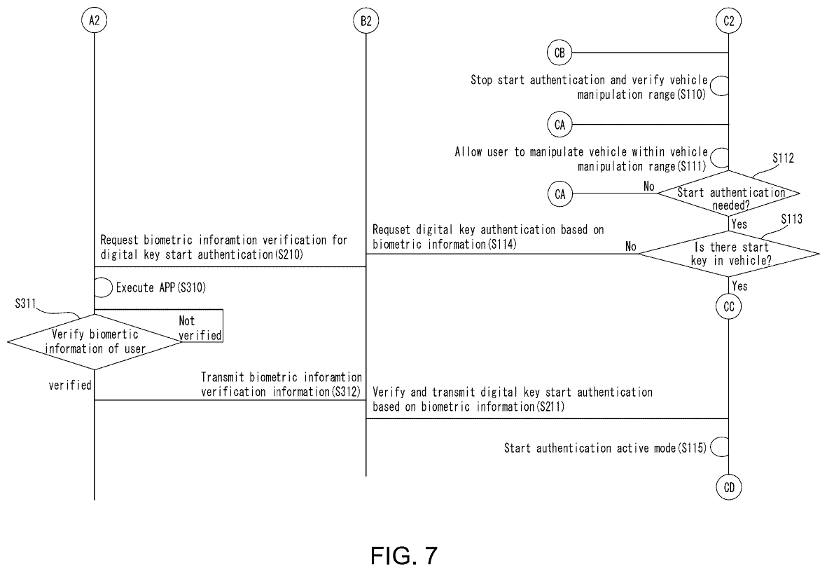

An operating process of the digital key system for a vehicle including the components shown in FIGS. 2 through 4 will be described below with reference to FIGS. 5 through 7. One or some, steps of the example method of FIGS. 5-7 may be omitted, performed in other orders, and/or otherwise modified, and/or one or more additional steps may be added.

In step S301, an application (also referred to herein as “APP”) may be initially executed and installed on the user terminal 300.

In step S302, if the installation of the APP is completed in step S301, the digital key management server interworking module 321 may request the digital key management server 200 to prepare an APP interworking mode.

After receiving the request for the preparation for the interworking mode in step S302 while checking vehicle information about a vehicle for which a digital key is managed in step S201, the digital key management server 200 may perform step S202 to start biometric information authentication according to the APP interworking mode and may perform step S203 to request the verification of the biometric information for digital key authentication.

In step S303, the user terminal 300 may verify the biometric information via the digital key authentication pop-up module 322. The user terminal 300 may recognize and verify the biometric information of the user via the user biometric information recognition unit 313.

In step S304, the user terminal 300 may notify the digital key management server 200 that the biometric information has been successfully verified on the APP.

In step S204, the digital key management server 200 may match and store, in a database (DB), the biometric information of the user to be used as pre-registered digital key authentication information of the vehicle.

A series of steps described above may be performed as a preceding process.

After the preceding process is complete, the vehicle (e.g., the vehicle 100) may determine whether the user terminal 300 is located closely (e.g., within a threshold distance) in step S101 as shown in FIG. 1. This may be performed based on the magnitude of an electric field strength generated if a BLE signal generated by the terminal BLE communication unit 312 in the user terminal 300 is received by the BLE communication unit 114 of the vehicle 100.

That is, the determination may be performed based on a median (e.g., between a minimum value and a maximum value) of the received field strength values of the BLE signal transmitted from the user terminal 300.

In step S102, if it is determined in step S101 that the user terminal 300 is close, the vehicle 100 may request the digital key management server 200 to authenticate the digital key based on the biometric information.

In step S105, the digital key management server 200 may then transmit, to the user terminal 300, a request for biometric information verification for digital key authentication.

The user terminal 300 may execute the APP in step S305 and may check whether the biometric information is verified through the digital key authentication pop-up module 322 in step S306.

In step S307, if the biometric information of the user is verified through the same step as step S303 described above, the user terminal 300 may transmit, to the digital key management server 200, information acquired from the biometric information verification.

In step S206, the digital key management server 200 may notify the vehicle 100 that the digital key authentication based on the biometric information is verified, based on the information acquired from the biometric information verification received in step S307.

In step S103, after receiving the notification that the digital key authentication based on the biometric information has been verified from the digital key management server 200 in step S206, the vehicle 100 may operate in a post-digital key authentication operation mode.

In step S104, the vehicle 100 may transmit, to the digital key management server 200, a request signal for checking whether there is a request from the user.

In step S207, the digital key management server 200 may then request the user terminal 300 to input the user request.

In step S308, the vehicle control request input module 323 of the user terminal 300 may then display a selection of requests for vehicle control (e.g., door unlocking or ignition on, etc.).

If the user enters a vehicle control request through the selection displayed in step S308, the biometric information may be requested once again.

In step S309, information about the user request along with a signal for (re-)verifying the biometric information of the user may then be provided to the digital key management server 200.

The digital key management server 200 may check the biometric information of the user and the vehicle control request in step S208 and may transmit the user request to the vehicle 100 in step S209.

In step S105, the vehicle 100 may check whether the user request received in step S209 includes vehicle start authentication.

In step S10, if it is determined that the vehicle start authentication is included, the vehicle 100 may unlock all the doors including one on the driver's seat and enter a start authentication active mode.

In this case, if the user opens the driver's door in step S107, the vehicle 100 may check whether there is an attempt to start the vehicle 100 within a certain time period in step S108, and if there is an attempt to start the vehicle 100 within the certain time period, may perform step S109 to perform a vehicle start-on operation and end the digital key authentication mode.

In contrast, if it is determined in step S106 that the driver's door is not opened or if there is no attempt to start the vehicle 100 within the certain time period in step S107, the vehicle 100 may perform step S110 to check such a start attempt suspension and an allowable vehicle manipulation range. In step S111, the vehicle 100 may allow the user to manipulate (or operate) the vehicle 100 within the checked allowable vehicle manipulation range.

In contrast, if it is determined in step S105 that the vehicle start authentication is not included, the vehicle 100 may perform step S111.

In step S112, the vehicle 100 may check whether the vehicle start authentication is required based on the manipulation of the vehicle 100 by the user, and if it is determined that the vehicle start authentication is required, may determine whether there is a start key in the vehicle 100. In this case, in step S114, if the start key is not present, the vehicle 100 may request the digital key management server 200 to perform the digital key authentication for starting the vehicle 100.

Accordingly, digital key start authentication based on the biometric information may be verified through a process in steps S210, S310 to step 312, and S211, and upon receiving information based on this digital key start authentication, the vehicle 100 may enter the vehicle start authentication active mode in step S115.

Thus, even for a user possessing a terminal that does not have a UWB communication function, it is possible to verify biometric information (including a fingerprint) of a pre-authenticated user through an application on a user terminal that interworks with a digital key management server that operates a remote vehicle control service, and to perform digital key authentication through the digital key management server. Therefore, it is possible to increase the efficiency of a digital key authentication control technology, expand the usability of a digital key, enhance the user convenience, and greatly reduce the production cost of a vehicle without a need for a separate additional device in the vehicle.

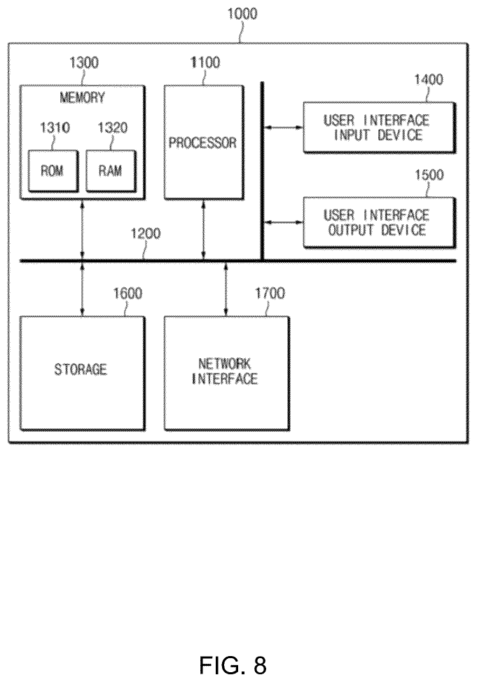

FIG. 8 shows an example computing system (e.g., a computing device of a vehicle or any other apparatus). One or more controllers, processors, etc. described herein may be implemented by the computing system or may be implemented in the computing system.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

There is provided a digital key system for a vehicle, including: a user terminal configured to perform authentication based on biometric identification information of a user in response to a digital key authentication request; a digital key management server configured to transmit the digital key authentication request to the user terminal and receive an authentication execution result, which is a result of performing the authentication, from the user terminal; and a vehicle including an authentication control unit configured to generate and transmit the digital key authentication request to the digital key management server when the user terminal is located within a predetermined threshold range, and to receive the authentication execution result from the digital key management server.

The biometric identification information may include fingerprint information, iris information, facial recognition information, and/or finger vein recognition information.

The threshold range may be based on a median value between a minimum value and a maximum value of Bluetooth Low Energy (BLE) electric field strength.

The user terminal may be further configured to: generate and transmit a vehicle control request to the digital key management server.

The vehicle may be further configured to: perform vehicle control based on the vehicle control request.

There is provided an operating method of a digital key system including a user terminal, a digital key management server, and a vehicle. The operating method may include transmitting, by the vehicle, a digital key authentication request to the digital key management server when the user terminal is located within a predetermined threshold range, transmitting, by the digital key management server, the digital key authentication request to the user terminal, performing, by the user terminal, user verification based on biometric identification information, responding, by the user terminal, to the digital key management server with a result of the performing the user verification, and notifying, by the digital key management server, the vehicle of a result of digital key authentication in response that the digital key management server receives a result of the performing the user verification from the user terminal.

The method may further comprise in response to being notified of the result of digital key authentication, transmitting, by the vehicle, a request to verify a signal for controlling the vehicle to the digital key management server.

The method may further comprise in response to the request to verify the signal for controlling the vehicle, transmitting, by the digital key management server, a request to select one of requests for controlling the vehicle to the user terminal.

The method may further comprise in response to the request to select one of the requests, transmitting, by the user terminal, selection information about the selected request to the digital key management server, re-performing, by the user terminal, the user verification based on the biometric identification information, and transmitting, by the user terminal, a result of the re-performing the user verification to the digital key management server.

The method may further comprise in response to receiving the result of the re-performing the user verification and the selection information, transmitting, by the digital key management server, the selection information to the vehicle.

The method may further comprise performing, by the vehicle, vehicle control based on the selection information.

While one or more example embodiments of the present disclosure have been shown and described above, the present disclosure is not limited to the example embodiments described above, various changes and modifications may be made by one of ordinary skill in the art to which the present disclosure pertains without departing from the spirit and scope of the disclosure, and such changes and modifications should not be construed as being independent of the technical ideas or views of the present disclosure.

What is claimed is:

1. A vehicle digital key system comprising:
a digital key management server; and
a vehicle configured to:
transmit, to the digital key management server and based on a user terminal being located within a threshold distance from the vehicle, a digital key authentication request,
wherein the digital key management server is configured to:
transmit, to the user terminal, the digital key authentication request,
wherein the digital key authentication request causes the user terminal to:
perform, based on the digital key authentication request and based on biometric identification information of a user, authentication of the user; and
transmit, to the digital key management server, an authentication response indicating a result of the authentication,
wherein the digital key management server is further configured to:
transmit, to the vehicle, the authentication response, and
wherein the vehicle is further configured to:
perform, based on the authentication response, an operation of the vehicle.

2. The vehicle digital key system of claim 1, wherein the biometric identification information comprises at least one of: fingerprint information, iris information, facial feature information, or finger vein recognition information.

3. The vehicle digital key system of claim 1, wherein the threshold distance is determined based on a median of Bluetooth Low Energy (BLE) electric field strength values.

4. The vehicle digital key system of claim 1, wherein the digital key management server is further configured to:
receive, from the user terminal, a vehicle control request associated with the vehicle.

5. The vehicle digital key system of claim 4, wherein the vehicle is configured to perform the operation of the vehicle by:
performing the operation based on the vehicle control request.

6. A method performed by an apparatus of a vehicle, the method comprising:
detecting a user terminal being located within a threshold distance from the vehicle;
based on the detecting of the user terminal located within the threshold distance from the vehicle, transmitting, to the user terminal via a digital key management server, a digital key authentication request;
receiving, from the digital key management server, an authentication response indicating a result of authentication performed, based on biometric identification information of a user, by the user terminal; and
performing, based on the authentication response, an operation of the vehicle.

7. The method of claim 6, wherein the receiving of the authentication response comprises receiving the authentication response from the user terminal via the digital key management server.

8. The method of claim 6, further comprising:
based on receiving of the authentication response, transmitting, by the vehicle to the digital key management server, a request to verify a signal for controlling the vehicle.

9. The method of claim 8, further comprising:
transmitting, by the digital key management server to the user terminal, a request to select one of a plurality of operations associated with control of the vehicle.

10. The method of claim 6, further comprising:
receiving, from the user terminal via the digital key management server, a vehicle control request associated with the operation of the vehicle.

11. The method of claim 10, wherein the receiving of the vehicle control request is based on a result of a second authentication performed by the user terminal.

12. The method of claim 10, wherein the performing of the operation of the vehicle comprises:
performing the operation based on the vehicle control request.

13. A method performed by a server, the method comprising:
receiving, from a vehicle and based on a user terminal being located within a threshold distance from the vehicle, a digital key authentication request;
transmitting, to the user terminal, the digital key authentication request;
receiving, from the user terminal, an authentication response indicating a result of authentication performed, based on biometric identification information of a user, by the user terminal; and
causing the vehicle to perform an operation, wherein the causing of the vehicle to perform the operation comprises transmitting the authentication response to the vehicle.

14. The method of claim 13, further comprising:
receiving, from the vehicle, a request to verify a signal for controlling the vehicle.

15. The method of claim 14, further comprising:
transmitting, to the user terminal and based on the receiving of the request to verify the signal for controlling the vehicle, a request to select one of a plurality of operations associated with control of the vehicle.

16. The method of claim 13, further comprising:
receiving, from the user terminal, a vehicle control request indicating the operation.

17. The method of claim 16, further comprising:
transmitting, to the user terminal and based on the receiving of the vehicle control request, a request to perform a second authentication of the user;
receiving, from the user terminal, a result of the second authentication; and
transmitting, based on the result of the second authentication, the vehicle control request to the vehicle.

18. The method of claim 16, wherein the causing of the vehicle to perform the operation further comprises transmitting, to the vehicle, the vehicle control request.
